(19) United States
(12) Patent Application Publication
(10) Pub. No.: US 2025/0150123 A1
(43) Pub. Date: May 8, 2025

(54) WIRELESS COMMUNICATION SYSTEM, WIRELESS COMMUNICATION METHOD, AND WIRELESS COMMUNICATION DEVICE

(71) Applicant: NIPPON TELEGRAPH AND TELEPHONE CORPORATION, Tokyo (JP)

(72) Inventors: Koyo TATEGAMI, Musashino-shi, Tokyo (JP); Daisuke GOTO, Musashino-shi, Tokyo (JP); Fumihiro YAMASHITA, Musashino-shi, Tokyo (JP); Kiyohiko ITOKAWA, Musashino-shi, Tokyo (JP)

(73) Assignee: NIPPON TELEGRAPH AND TELEPHONE CORPORATION, Tokyo (JP)

(21) Appl. No.: 18/837,609

(22) PCT Filed: Feb. 17, 2022
(86) PCT No.: PCT/JP2022/006406

§ 371 Date: Aug. 12, 2024

(51) Int. Cl. H04B 7/0456; H04B 17/309

(52) U.S. Cl. CPC H04B 7/0456; H04B 17/309

(57) ABSTRACT

The transmitting station or the receiving station estimates channel information. All combinations of sub-array configurations in accordance with the number of transmitting antennas, the number of receiving antennas, and the number of transmission signals are derived. For the all combinations, precoding matrices which can be combined in-phase with the selected receiving antennas are derived. The channel capacity for the all combinations from the channel information and the precoding matrix is calculated. The optimal precoding matrix which maximizes channel capacity is selected. The transmission-side control information is determined from the optimal precoding matrix. The transmitting station switches the output destination of a single signal or a plurality of signals on the basis of the transmission-side control information and forms an arbitrary sub-array corresponding to each signal. The sub-array performs in-phase combining using phase control for the desired receiving antenna. The receiving station combines, separates, and demodulates the signals.

### TECHNICAL FIELD

The present disclosure relates to a wireless communication system, a wireless communication method, and a wireless communication device, and particularly relates to a wireless communication system, a wireless communication method, and a wireless communication device suitable for line-of-sight MIMO transmission involving movement of a transmitting/receiving stations.

### BACKGROUND ART

Low Earth Orbit (LEO) satellites are known to have various advantages when used in communication systems because they are closer to the Earth's surface than Geostationary Earth Orbit (GEO). For example, it is possible to significantly reduce propagation delay by reducing the distance between the satellite and the ground station to 1/10 or less. Furthermore, since the propagation loss is small due to the short propagation distance, it is possible to reduce the power consumption of the transmitter. Along with this, satellites and terrestrial terminal stations can be made smaller and device costs can be expected to be reduced.

When increasing the communication capacity of ground terminals in a LEO satellite communication system or increasing the number of terminals which can be accommodated, the feeder link line which communicates with the base station also needs to have a large capacity. NPL 1 discloses a multiple-input multiple-output (MIMO) technique which performs spatial multiplexing transmission using a plurality of antennas as a method for increasing communication capacity. In order to increase capacity, it is desirable to utilize a MIMO technique.

### CITATION LIST

### Non Patent Literature

[NPL 1] A. Knopp, R. T. Schwarz, D. Ogermann, C. A. Hofmann and B. Lankl, “Satellite System Design Examples for Maximum MIMO Spectral Efficiency in LOS Channels,” IEEE GLOBECOM 2008-2008 IEEE Global Telecommunications Conference, 2008, pp. 1-6.
[NPL 2] Takanobu WATANABE, Kentaro NISHIMORI, “Evaluation of Channel Capacity Characteristics for Asymmetric LoS-MIMO,” IEICE Technical Report, vol. 121, No. 133, CQ2021-21, pp. 1-5, August 2021
[NPL 3] C. Xue, S. He, F. Ou, M. Wei, Y. Huang and L. Yang, “Asymmetric subarray structure design for mmWave LOS MIMO communication systems,” 2016 IEEE/CIC International Conference on Communications in China (ICCC), 2016, pp. 1-6.

### SUMMARY OF INVENTION

### Technical Problem

However, in MIMO wireless communication systems in the related art using LEO satellites which are constantly moving and in a line-of-sight environment, there are cases in which the channel correlation between transmitting and receiving becomes high, resulting in issues with reduced channel capacity and communication line stability.

In order to address the above-mentioned problems, NPL 2 discloses a method of installing more antennas than the number of signals to be transmitted on one or both of the transmitting and receiving sides to perform eigenmode transmission. However, in eigenmode transmission, when precoding on the transmitting side, a plurality of different signals are superimposed and transmitted from an antenna. Therefore, there is a problem that a signal peak signal having a very large power compared to the average power is generated, that is, a problem that the peak-to-average power ratio PAPR increases. When such an excessively large signal is input to a transmission power amplifier or the like, distortion occurs in the output signal, causing deterioration in transmission quality. When devices with excellent input/output characteristics are used, it is possible to reduce distortion even for large peak signals, but this leads to an increase in power consumption.

In addition, NPL 3 discloses a line-of-sight MIMO transmission method which utilizes the gain of an array antenna and in which a sub-array is formed for a signal to be transmitted and each sub-array performs in-phase combining to a desired receiving antenna. With this method, it is possible to increase the received SNR by in-phase combining without increasing the PAPR. However, since the sub-array configuration is fixed, there are problems such as the possibility that the channel correlation cannot be reduced and the number of transmission signals cannot be changed, making it difficult to perform large-capacity and stable communication.

In order to solve the above problems, a first object of the present disclosure is to provide a wireless communication system which can increase the capacity and improve the stability of wireless communication while suppressing an increase in PAPR when performing line-of-sight MIMO transmission which involves movement of transmitting and receiving stations.

Also, in order to solve the above problems, a second object of the present disclosure is to provide a wireless communication method which can increase the capacity and improve the stability of wireless communication while suppressing an increase in PAPR when performing line-of-sight MIMO transmission which involves movement of transmitting and receiving stations.

Furthermore, in order to solve the above problems, a third object of the present disclosure is to provide a wireless communication device which can increase the capacity and improve the stability of wireless communication while suppressing an increase in PAPR when performing line-of-sight MIMO transmission which involves movement of transmitting and receiving stations.

### Solution to Problem

It is preferable that a first aspect of the present disclosure be a wireless communication system using a transmitting station and a receiving station including a plurality of antennas, in which the transmitting station or the receiving station has: a function of estimating channel information between the transmitting antenna and the receiving antenna; a function of deriving all combinations of sub-array configurations in accordance with the number of transmitting antennas, the number of receiving antennas and the number of transmission signals; a function of deriving a precoding matrix which allows in-phase combining for selected receiving antennas for all the combinations; a function of calculating a channel capacity for all combinations from the channel information and the precoding matrix; a function of selecting an optimal precoding matrix which maximizes the channel capacity; and a function of determining transmission-side control information from the optimal precoding matrix, the transmitting station has: a function of switching an output destination of a single or a plurality of signals on the basis of the transmission-side control information and forming an arbitrary sub-array corresponding to each signal; and a function of performing in-phase combining using phase control on the desired receiving antenna using the sub-array, and the receiving station has a function of combining, separating, and demodulating the signals transmitted from the transmitting station.

It is preferable that a second aspect of the present disclosure be a wireless communication method using a transmitting station and a receiving station including a plurality of antennas including: a process of estimating channel information between a transmitting antenna and a receiving antenna; a process of deriving all combinations of sub-array configurations according to the number of transmitting antennas, the number of receiving antennas, and the number of transmission signals; a process of deriving a precoding matrix which allows in-phase combining for the selected receiving antennas for all the combinations; a process of calculating channel capacity for all combinations from the channel information and the precoding matrix; a process of selecting an optimal precoding matrix which maximizes the channel capacity; a process of determining transmission-side control information from the optimal precoding matrix; a process of switching an output destination of a single or a plurality of signals on the basis of the transmission-side control information and forming an arbitrary sub-array corresponding to each signal; a process of performing in-phase combining by performing phase control on the desired receiving antenna using the sub-array; and a process of combining, separating, and demodulating signals transmitted from the transmitting station.

It is preferable that a third aspect of the present disclosure be a wireless communication device including: a channel information estimation part, a channel capacity calculation part, a control information calculation part, a serial/parallel conversion part, a transmission signal generation part, a transmission antenna selection part, a phase control part, and a reception signal demodulation part, in which the channel information estimation part has a function of estimating channel information between a transmitting antenna and a receiving antenna, the channel capacity calculation part has a function of deriving all combinations of sub-array configurations according to the number of transmitting antennas, the number of receiving antennas, and the number of transmission signals, a function of deriving a precoding matrix which allows in-phase combining for the selected receiving antennas for all the combinations, and a function of calculating a channel capacity for all combinations from the channel information and the precoding matrix, the control information calculation part has a function of selecting an optimal precoding matrix which maximizes the channel capacity, a function of determining transmission-side control information from the optimal precoding matrix, and a function of notifying the serial/parallel conversion part, the transmission signal generation part, the transmission antenna selection part, and the phase control part of control information, the serial/parallel conversion part has a function of parallelizing bit information into the number of transmission signals on the basis of the transmission-side control information, the transmission signal generation part has a function of modulating a bit string on the basis of the transmission-side control information and converting it into an electrical signal, the transmission antenna selection part has a function of selecting an antenna on the basis of the transmission-side control information to switch an output destination of a single or a plurality of signals and configure a sub-array of an arbitrary shape, the phase control part has a function of controlling a phase coefficient so that in-phase combining is performed on a desired receiving antenna on the basis of the transmission-side control information, and the reception signal demodulation part has a function of increasing a received SNR by performing signal combining on the basis of the channel information, and a function of separating interfering signals.

### Advantageous Effects of Invention

According to the first to third aspects of the present disclosure, it is possible to increase the capacity and improve the stability of wireless communication while suppressing the increase in PAPR when performing line-of-sight MIMO transmission which involves movement of the transmitting and receiving stations.

### BRIEF DESCRIPTION OF DRAWINGS

FIG. 1 is a diagram illustrating a configuration example of a wireless communication system according to a first embodiment of the present disclosure.

FIG. 2 is a functional block diagram of the wireless communication system according to the first embodiment of the present disclosure.

FIG. 3 is a flowchart for describing an example of an operation of a transmitting station and a receiving station according to the first embodiment of the present disclosure.

FIG. 4 is a diagram illustrating an operation example of channel information acquisition according to the first embodiment of the present disclosure.

FIG. 5 is a diagram illustrating an operation example of a channel capacity calculation part according to the first embodiment of the present disclosure.

FIG. 6 is a diagram illustrating an operation example of a control information calculation part according to the first embodiment of the present disclosure.

FIG. 7 is a diagram illustrating a first operation example of a receiving station after receiving a signal according to the first embodiment of the present disclosure.

FIG. 8 is a diagram illustrating a second operation example of a receiving station after receiving signal according to the first embodiment of the present disclosure.

FIG. 9 is a functional block diagram of a wireless communication system according to a second embodiment of the present disclosure.

FIG. 10 is a flowchart for describing an example of an operation of a transmitting station and a receiving station according to the second embodiment of the present disclosure.

FIG. 11 is a diagram illustrating a configuration example of a wireless communication system according to a third embodiment of the present disclosure.

FIG. 12 is a functional block diagram of a wireless communication system according to the third embodiment of the present disclosure.

FIG. 13 is a flowchart for describing an operation example of a transmitting station, a receiving station, and a control station according to the third embodiment of the present disclosure.

FIG. 14 is a diagram illustrating a configuration example of a wireless communication system according to a fourth embodiment of the present disclosure.

FIG. 15 is a flowchart for describing an operation example of a transmitting station, a receiving station, and a control station according to the fourth embodiment of the present disclosure.

### DESCRIPTION OF EMBODIMENTS

### First Embodiment

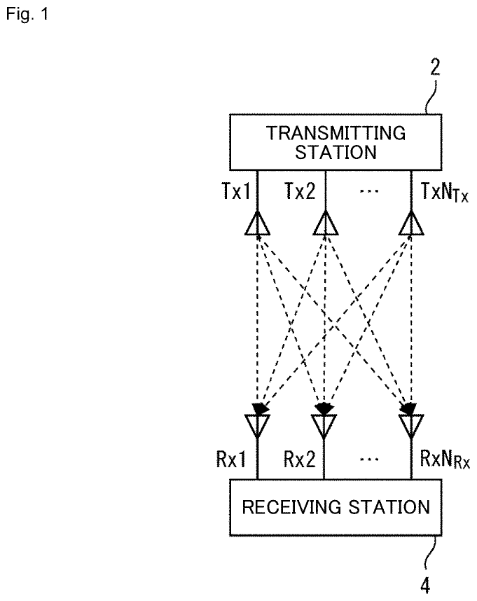

FIG. 1 is a diagram illustrating a configuration example of a wireless communication system according to a first embodiment of the present disclosure. This wireless communication system includes a transmitting station 2 and a receiving station 4. The transmitting station 2 has one or more transmitting antennas Tx and the receiving station 4 has one or more receiving antennas Rx. For example, the transmitting station 2 is a LEO satellite including a plurality of antennas and moving in a service area and the receiving station 4 is a satellite base station. Note that the transmitting station 2 is not limited to a LEO satellite, the receiving station 4 is not limited to a base station, and any transmission/reception station including a plurality of antennas may be used.

The transmitting station 2 and the receiving station 4 perform wireless MIMO communication. At this time, the receiving station 4 includes a function of estimating channel information on the basis of the broadcast information from the transmitting station 2. Note that the distances between the plurality of antennas provided in each of the transmitting station 2 and the receiving station 4 are arranged so that the channel correlation is low.

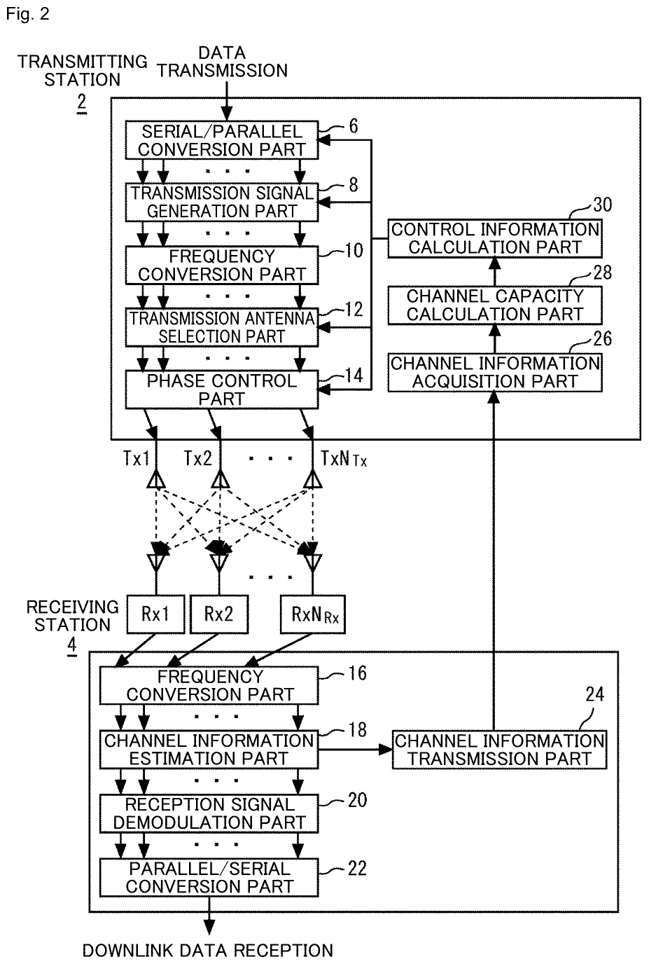

FIG. 2 is a functional block diagram of the wireless communication system according to the first embodiment of the present disclosure. First, a normal downlink data path will be explained. The data transmitted from the transmitting station 2 is first subjected to serial/parallel conversion of bit information in a serial/parallel conversion part 6 and is input to a transmission signal generation part 8. The number of parallel signals at this time is determined using the number of transmission signals obtained from a control information calculation part 30.

The transmission signal generation part 8 modulates the input bit information, converts it into an electrical signal, and transmits it to a frequency conversion part 10. The modulation method is determined for each signal using the modulation method obtained from the control information calculation part.

The frequency conversion part 10 converts the electrical signal into a wireless signal of a predetermined frequency to be transmitted from an antenna and transmits the wireless signal to a transmission antenna selection part 12. The transmission antenna selection part 12 selects an antenna corresponding to each signal on the basis of the control information input from control information calculation part 30 and transmits a signal to which the information is added to a phase control part 14.

The phase control part 14 controls the antenna directivity of each signal by controlling the phase so that each signal is combined in phase with a desired receiving antenna. The phase coefficient of each antenna is determined using the control information calculation part 30.

The signal transmitted in the transmitting station 2 as described above is transmitted to the receiving station 4 by being transmitted from the transmitting antenna Tx to the receiving antenna Rx. The transmission signal is first transmitted to a frequency conversion part 16 included in the receiving station 4.

The frequency conversion part 16 converts the wireless signal into an electrical signal of a predetermined frequency and transmits the electrical signal to a channel information estimation part 18. The channel information estimation part 18 estimates channel information from the received signal and transmits it to a reception signal demodulation part 20. It is assumed herein that the estimable channel information is two types, before and after precoding.

The reception signal demodulation part 20 uses the input channel matrix after precoding to separate interference signals, demodulates the electrical signal into bit information, and transmits the bit information to the parallel/serial conversion part 22. The parallel/serial conversion part 22 parallel/serial converts the bit information. Downlink data reception is completed by the above.

A path for acquiring channel information H before precoding through feedback by transmitting a known pilot signal will be described below. First, a pilot signal is transmitted from the transmitting station 2 to the receiving station 4 through the same path as the data transmission described above. The pilot signal is transmitted to the channel information estimation part 18 via the frequency conversion part 16. The channel information estimation part 18 estimates channel information H before precoding and transmits the channel information H to a channel information transmission part 24.

The channel information transmission part 24 transmits channel information H to a channel information acquisition part 26 included in the transmitting station 2. The channel information acquisition part 26 transmits the acquired channel information H to a channel capacity calculation part 28. The channel capacity calculation part 28 derives all combinations of transmitting antennas/receiving antennas/number of transmission signals. Also, the channel capacity for all combinations is calculated from the channel information H and transmitted to the control information calculation part 30.

The control information calculation part 30 determines the number of transmission signals for which channel capacity is maximized/the communication method of each signal/the antenna output destination and sub-array configuration of the signal/the phase coefficient of each antenna on the basis of the acquired information. Furthermore, the transmission signal number information is transmitted to the serial/parallel conversion part 6, the communication method of each signal is transmitted to the transmission signal generation part 8, the antenna output destination and sub-array configuration of the signal are transmitted to the transmission antenna selection part 12, and the phase coefficient of each antenna is transmitted to the phase control part 14. Through this feedback, this embodiment realizes optimization of wireless communication.

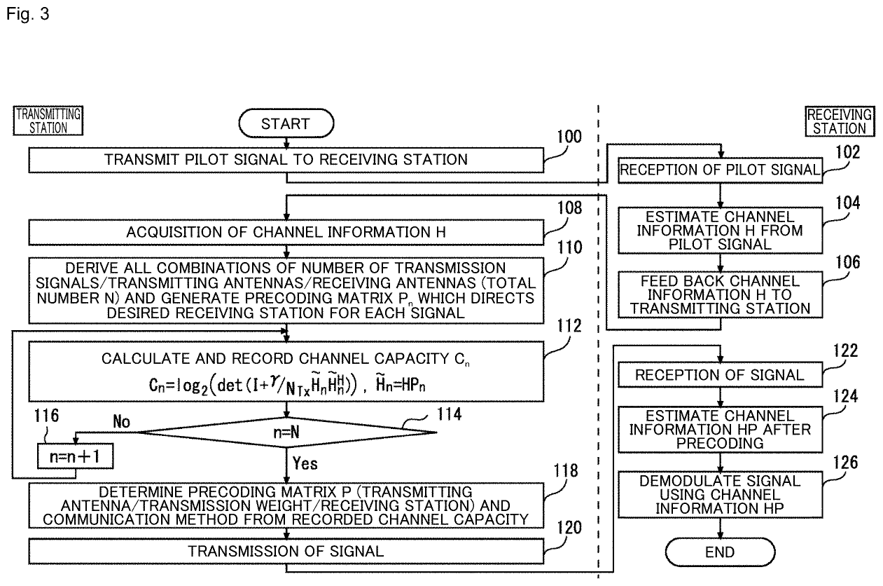

FIG. 3 is a flowchart for describing an example of an operation of the transmitting station and the receiving station according to the first embodiment of the present disclosure. According to this flowchart, as a specific operation example of the wireless communication system according to this embodiment, a process of acquiring the above-mentioned channel information H will be described.

First, in Step 100, the transmitting station 2 transmits a known pilot signal to the receiving station 4. The receiving station 4 receives the pilot signal in Step 102 and estimates channel information H in Step 104. This estimation is performed by the channel information estimation part 18 and the estimated channel information H is obtained before precoding. Furthermore, in Step 106, the receiving station 4 transmits the estimated channel information H to the transmitting station 2 as feedback.

In Step 108, the channel information acquisition part 26 of the transmitting station 2 acquires the channel information H transmitted from the receiving station 4. Subsequently, in Step 110, the channel capacity calculation part 28 of the transmitting station 2 derives all combinations of the number of transmission signals/transmitting antennas/receiving antennas and generates an optimum precoding matrix for all combinations. Here, the precoding matrix is a matrix Pₙ(n=1, 2, . . . , N) including the information on the number of transmission signals/transmitting antennas/receiving antennas, in which N is the total number of all combinations described above.

The procedure for generating the precoding matrix Pₙ is as follows. First, all combinations of the number of transmission signals, transmitting antennas which output each signal, and desired receiving antennas for each signal are derived. Subsequently, phase coefficients for performing in-phase combining for the receiving antennas selected in each combination are derived on the basis of the channel information H acquired in Step 108. As a result, all precoding matrices Pₙ for the total number N are generated.

Subsequently, in Step 112, the channel capacity Cn of all combinations is derived using the channel information H and the precoding matrix Pₙ and the recorded data is transmitted to the control information calculation part 30. A channel capacity Cn can be derived using Expression 1.

$${c}_{n} = {log}_{2} ( det ( I + γ / {N}_{T x} , {\tilde{H}}_{n} {\tilde{H}}_{n}^{H} ) ) , {\tilde{H}}_{n} = H {P}_{n} \qquad [ Math . 1 ]$$

Here, I is the identity matrix, γ is the reception SNR, and N_{Tx} is the number of transmitting antennas.

Subsequently, in Step 114, it is confirmed whether n=N is satisfied. When n=N is not satisfied, the process proceeds to Step 116 and the process of Step 112 is repeatedly performed using n=n+1 as n. When n=N is satisfied, the process proceeds to Step 118.

In Step 118, the control information calculation part 30 selects the maximum channel capacity C from the input channel capacities and acquires the precoding matrix P used for a derivation thereof. Subsequently, the number of transmission signals included in the precoding matrix P, the antennas which output each signal, and the phase coefficient of each antenna are output to the serial/parallel conversion part 6, the transmission antenna selection part 12, and the phase control part 14 of the transmitting station, respectively. Furthermore, a modulation multilevel number or a communication method such as an error correction coding rate of each signal is determined on the basis of the channel capacity C and output to the transmission signal generation part 8.

Furthermore, in Step 120, the signals to be actually exchanged are transmitted from the transmitting station 2 to the receiving station 4. At this time, it is assumed that the signal radiated from the transmitting antenna Tₓ is subjected to parallel conversion of data bit strings, transmission signal generation, frequency conversion, transmission antenna selection for each signal, and phase control on the basis of the information output from the control information calculation part 30 in Step 118.

Subsequently, in Step 122, the receiving station 4 receives the signal using the receiving antenna Rₓ. Subsequently, in Step 124, the channel information estimation part 18 uses the reception signal to estimate the channel information HP after precoding. Furthermore, in Step 126, the reception signal demodulation part 20 separates the interfering signals on the basis of the channel information HP using an algorithm such as ZF or MMSE and converts each signal into a bit string. Here, the process ends.

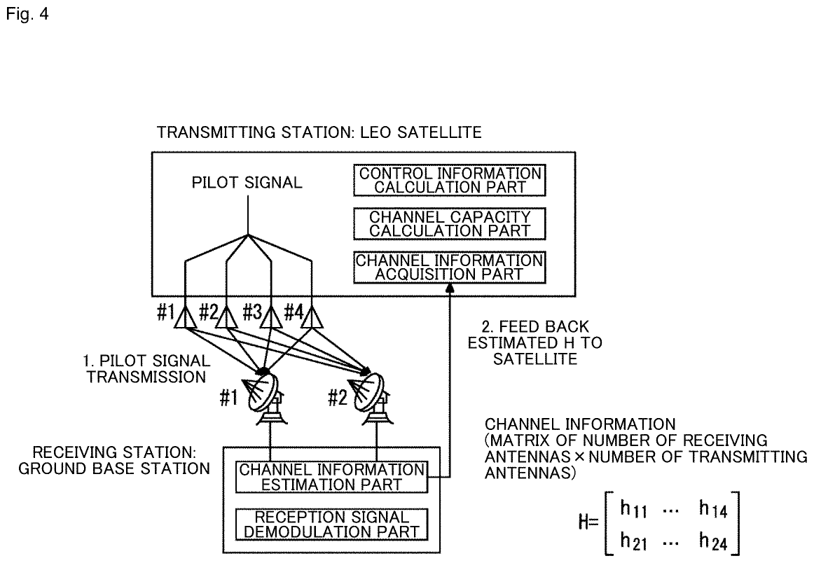

An operation example of the first embodiment will be explained in more detail. FIG. 4 is a diagram illustrating an operation example of channel information acquisition according to the first embodiment of the present disclosure. In the wireless communication system 1 used in the following operation examples, the number of antennas at the transmitting station 2 is four and the number of antennas at the receiving station is two. The transmitting station 2 is a LEO satellite, the receiving station 4 is a ground base station and the receiving antenna Rₓ is a ground station antenna using a directional antenna such as a parabolic antenna.

First, the LEO satellite transmits a known pilot signal to a ground station antenna. This transmission uses all transmitting antennas Tₓ and does not perform phase control. A ground base station estimates channel information as a matrix H of the number of receiving antennas×the number of transmitting antennas. The matrix H in this case is represented by the expression of Expression 2.

$$H = [ \begin{matrix}{h}_{11} & … & {h}_{14} \\ {h}_{21} & … & {h}_{24}\end{matrix} ] \qquad [ Math . 2 ]$$

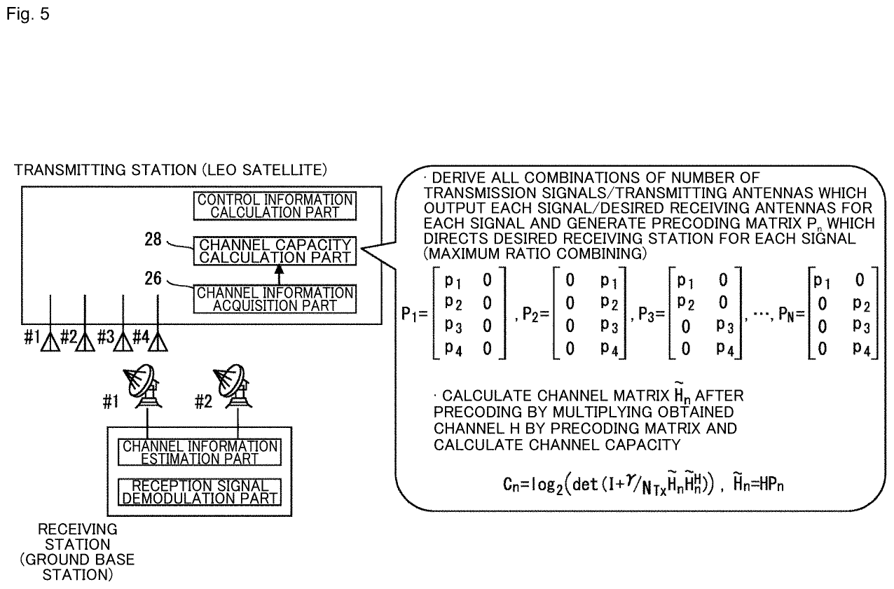

FIG. 5 is a diagram illustrating an example of an operation of the channel capacity calculation part according to the first embodiment of the present disclosure. First, the channel capacity calculation part 28 acquires the estimated channel information H from the channel information acquisition part 26. Also, all combinations of the number of transmission signals/transmitting antennas which output each signal/desired receiving antennas for each signal are derived and a precoding matrix Pₙ whose directivity is directed toward a desired receiving antenna for each signal, that is, in-phase combining is generated.

At this time, the precoding matrix Pₙ is a matrix of the number of transmitting antennas×the number of receiving antennas. Each row vector of the matrix has one value and the other elements are 0. Components of a first column vector are phase coefficients for performing in-phase combining on a ground station antenna #1 and components of a second column vector are phase coefficients for performing in-phase combining on a ground station antenna #2. Furthermore, the number of ranks of matrix Pₙ becomes the number of transmission signals.

For example, when the number of transmission signals is 1, assuming that P₁ is a precoding matrix at the time of performing in-phase combining for a ground station antenna #1 and P₂ is a precoding matrix at the time of performing in-phase combining for a ground station antenna #2, these are represented by the numbers 3 and 4.

$${P}_{1} = [ \begin{matrix}{p}_{1} & 0 \\ {p}_{2} & 0 \\ {p}_{3} & 0 \\ {p}_{4} & 0\end{matrix} ] \qquad [ Math . 3 ]$$

$${P}_{2} = [ \begin{matrix}0 \\ 0 \\ 0 \\ 0\end{matrix} \begin{matrix}{p}_{1} \\ {p}_{2} \\ {p}_{3} \\ {p}_{4}\end{matrix} ] \qquad [ Math . 4 ]$$

Also, when the transmission signal is 2, if it is assumed that the transmitting antennas #1 and #2 constitute a sub-array for a signal #1 and perform in-phase combining with the ground station antenna #1, the sub-array for a signal #2 is activated using transmitting antennas #3 and #4, and P₃ is a precoding matrix at the time of performing in-phase combining for a ground antenna #2, this is represented by Expression 5.

$${P}_{3} = [ \begin{matrix}{p}_{1} & 0 \\ {p}_{2} & 0 \\ 0 & {p}_{3} \\ 0 & {p}_{4}\end{matrix} ] \qquad [ Math . 5 ]$$

Subsequently, the channel matrix after each precoding is calculated through Expression 1 using the calculated precoding matrix Pₙ.

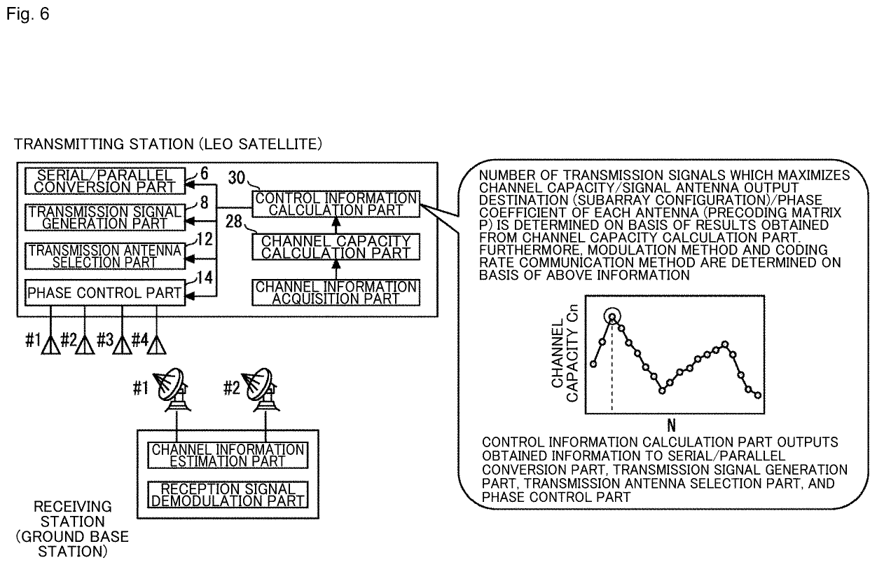

FIG. 6 is a diagram illustrating an example of an operation of the control information calculation part according to the first embodiment of the present disclosure. A control information calculation part 30 determines a precoding matrix P which maximizes a channel capacity on the basis of the result obtained using a channel capacity calculation part 28. If this is expressed using the expression, this is provided like Expression 6.

$$P = {P}_{i} \qquad [ Math . 6 ]$$

$$i = arg {max}_{1 \leq n \leq N} {C}_{n}$$

This precoding matrix P includes information on the number of transmission signals, the antenna output destination of the signal, the sub-array configuration, and the phase coefficient of each antenna. For this reason, communication methods such as modulation method and coding rate can be determined on the basis of this information. For example, when the number of transmission signals is 1, a modulation method with a large number of multi-values is used, and when the number of signals is 2, a modulation method with a small number of multi-values is used.

The information determined above is output to the serial/parallel conversion part 6, the transmission signal generation part 8, the transmission antenna selection part 12, and the phase control part 14.

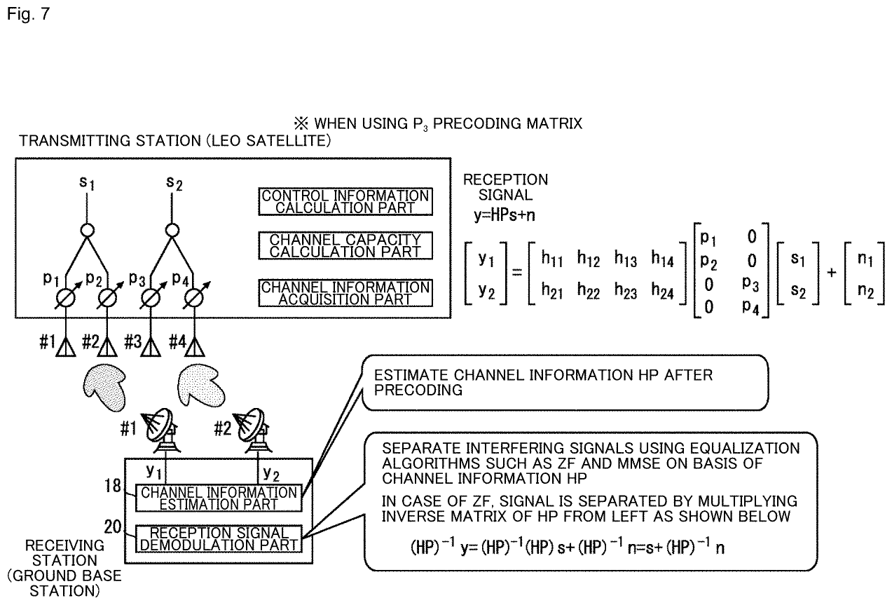

FIG. 7 is a diagram illustrating a first example of an operation of the receiving station after receiving a signal according to the first embodiment of the present disclosure. This operation example shows a case in which the precoding matrix P₃ is selected using the control information calculation part. When the precoding matrix P₃ is selected, it is assumed that two signals, s₁ to be in-phase combined to the receiving station #1 and s₂ to be in-phase combined to the receiving station #2 are transmitted.

When the received signal of the receiving station #1 is y₁ and the received signal of the receiving station #2 is y₂, the received signal vector is expressed by Expression 7 and each component thereof is expressed by Expression 8. Here, n is a thermal noise vector.

$$y = H P s + n \qquad [ Math . 7 ]$$

$$[ \begin{matrix}{y}_{1} \\ {y}_{2}\end{matrix} ] = [ \begin{matrix}{h}_{11} & {h}_{12} & {h}_{13} & {h}_{14} \\ {h}_{21} & {h}_{22} & {h}_{23} & {h}_{24}\end{matrix} ] [ \begin{matrix}{p}_{1} & 0 \\ {p}_{2} & 0 \\ 0 & {p}_{3} \\ 0 & {p}_{4}\end{matrix} ] [ \begin{matrix}{s}_{1} \\ {s}_{2}\end{matrix} ] + [ \begin{matrix}{n}_{1} \\ {n}_{2}\end{matrix} ] \qquad [ Math . 8 ]$$

At this time, the signal vector output from each antenna is a Ps term, and when expanded, it becomes Expression 9. As can be confirmed from Expression 9, the component of the signal output from each antenna is only the multiplied phase coefficient and the two signals are not combined. For this reason, an increase in PAPR does not occur.

$$Ps = [ \begin{matrix}{p}_{1} & 0 \\ {p}_{2} & 0 \\ 0 & {p}_{3} \\ 0 & {p}_{4}\end{matrix} ] [ \begin{matrix}{s}_{1} \\ {s}_{2}\end{matrix} ] = [ \begin{matrix}{p}_{1} {s}_{1} \\ {p}_{2} {s}_{1} \\ {p}_{3} {s}_{2} \\ {p}_{4} {s}_{2}\end{matrix} ] \qquad [ Math . 9 ]$$

The channel information estimation part 18 estimates channel information HP after precoding using this precoding matrix P₃ and inputs it to the reception signal demodulation part 20.

The reception signal demodulation part 20 separates the two mixed signals using the channel information HP. Any algorithm such as ZF, MMSE, or SIC can be used for signal separation. For example, when using the ZF algorithm, signals can be separated by multiplying from the left by the inverse matrix of HP as in Expression 10.

$${( H P )}^{- 1} y = {( H P )}^{- 1} ( H P ) s + {( H P )}^{- 1} n = s + {( H P )}^{- 1} n \qquad [ Math . 10 ]$$

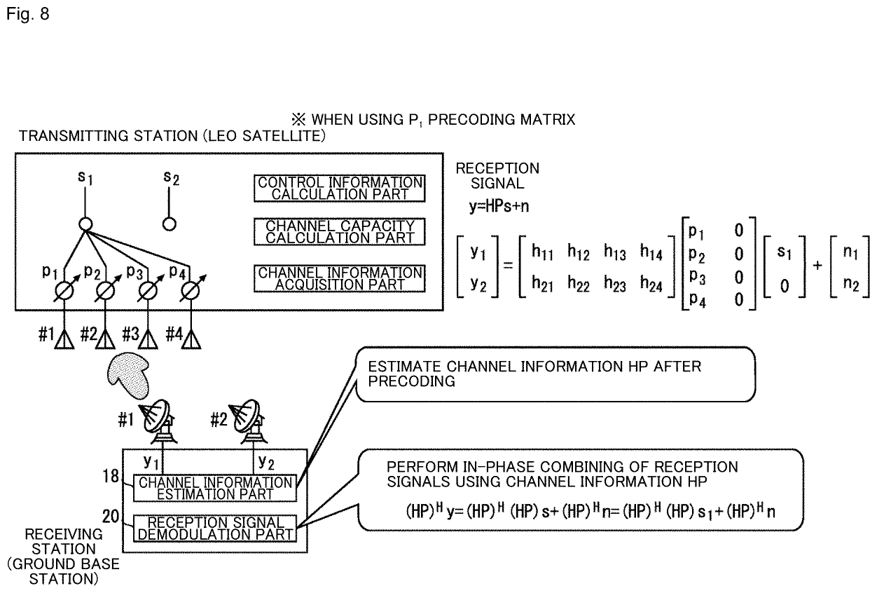

FIG. 8 is a diagram illustrating a second operation example of the receiving station after receiving a signal according to the first embodiment of the present disclosure. This operation example shows a case in which the precoding matrix P₁ is selected using the control information calculation part. When the precoding matrix P₁ is selected, it is assumed to transmit only one signal of s₁ to be in-phase combined to the receiving station #1. Note that, since side lobes are also formed at the time of forming the directivity, a slight signal is radiated to the receiving station #2 as well.

Assuming that the received signal of the receiving station #1 is y₁ and the received signal of the receiving station #2 is y₂, the received signal vector is represented by Expression 7 and each component thereof is represented by Expression 11.

$$[ \begin{matrix}{y}_{1} \\ {y}_{2}\end{matrix} ] = [ \begin{matrix}{h}_{11} & {h}_{12} & {h}_{13} & {h}_{14} \\ {h}_{21} & {h}_{22} & {h}_{23} & {h}_{24}\end{matrix} ] [ \begin{matrix}{p}_{1} & 0 \\ {p}_{2} & 0 \\ {p}_{3} & 0 \\ {p}_{4} & 0\end{matrix} ] [ \begin{matrix}{s}_{1} \\ 0\end{matrix} ] + [ \begin{matrix}{n}_{1} \\ {n}_{2}\end{matrix} ] \qquad [ Math . 11 ]$$

Using this precoding matrix P₁, the channel information estimation part 18 estimates channel information HP after precoding and inputs it to the reception signal demodulation part 20.

In this operation example, since there is only one transmission signal, the reception signal demodulation part 20 does not need to perform signal separation. Instead, the channel information HP is used for performing in-phase combining of the received signals according to the equation expressed by Expression 12. Since the HP is a 2×1 complex vector, a coefficient of s₁ becomes a real number, a signal obtained by multiplying a transmission signal by a real number is obtained.

$$[ Math . 12 ]$$

$${( H P )}^{H} y = {( H P )}^{H} ( H P ) s + {( H P )}^{H} n = {( H P )}^{H} ( H P ) {s}_{1} + {( H P )}^{H} n$$

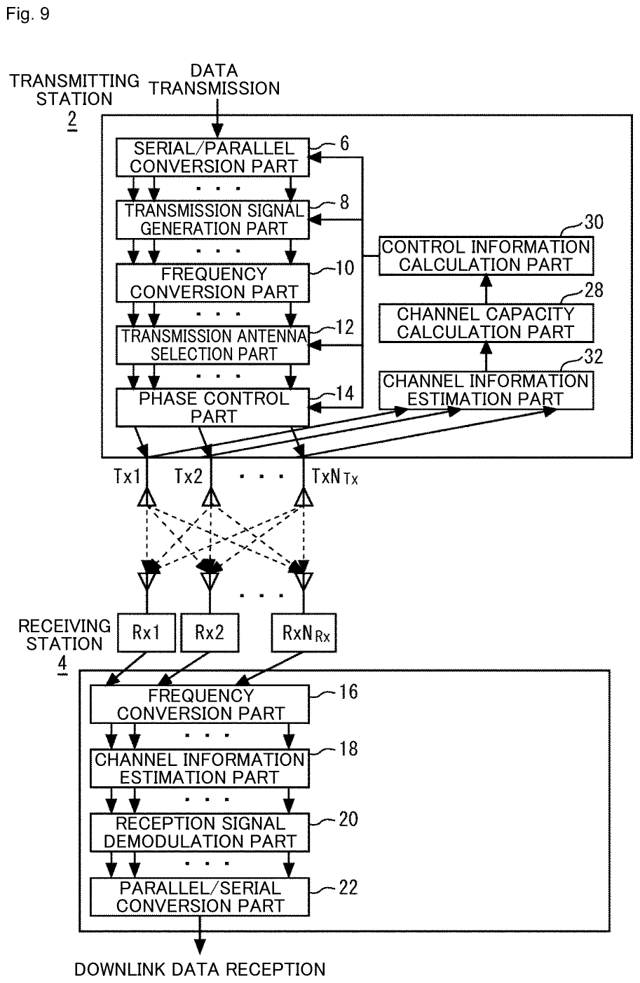

FIG. 9 is a functional block diagram of a wireless communication system according to a second embodiment of the present disclosure. In the first embodiment, when the transmitting station acquires channel information, a method in which the pilot signal transmitted from the transmitting station 2 is fed back is used. However, in the second embodiment, the transmitting station 2 includes the channel information estimation part 32 and the transmitting station 2 estimates channel information on the basis of the pilot signal transmitted from the receiving station 4.

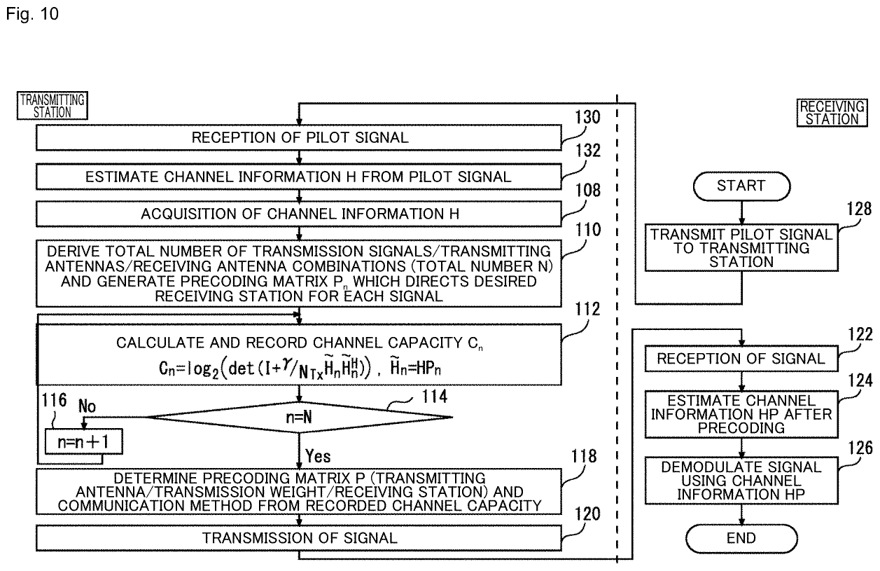

FIG. 10 is a flowchart for describing an example of an operation of the transmitting station and the receiving station according to the second embodiment of the present disclosure. First, in Step 128, the receiving station 4 transmits a known pilot signal to the transmitting station 2. The transmitting station 2 receives the pilot signal in Step 130 and estimates channel information H in Step 132. This estimation is performed using the channel information estimation part 32 and the estimated channel information H is provided before precoding. Subsequent Steps 108 to 126 are the same as in the first embodiment.

Note that, although channel information is estimated using a pilot signal in the second embodiment, channel information may be estimated using an uplink data signal.

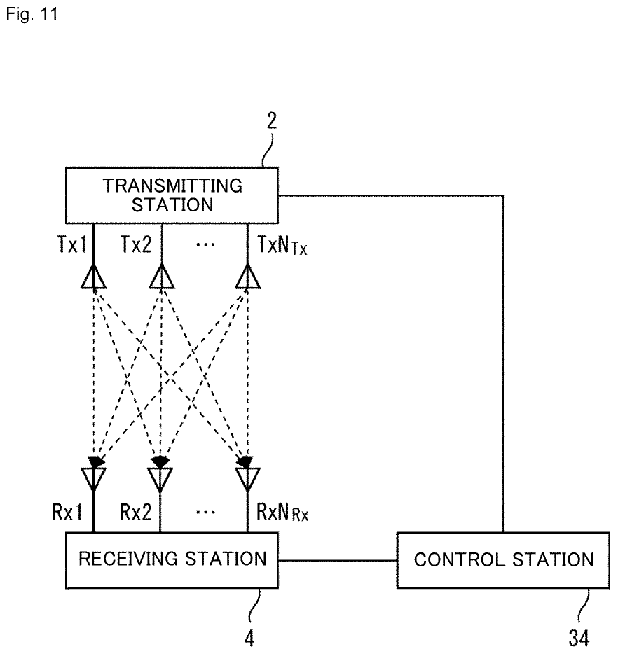

FIG. 11 is a diagram showing a configuration example of a wireless communication system according to a third embodiment of the present disclosure. This wireless communication system includes a control station 34 in addition to the transmitting station 2 and the receiving station 4. The control station 34 is responsible for the pilot signal processing performed in the first and second embodiments.

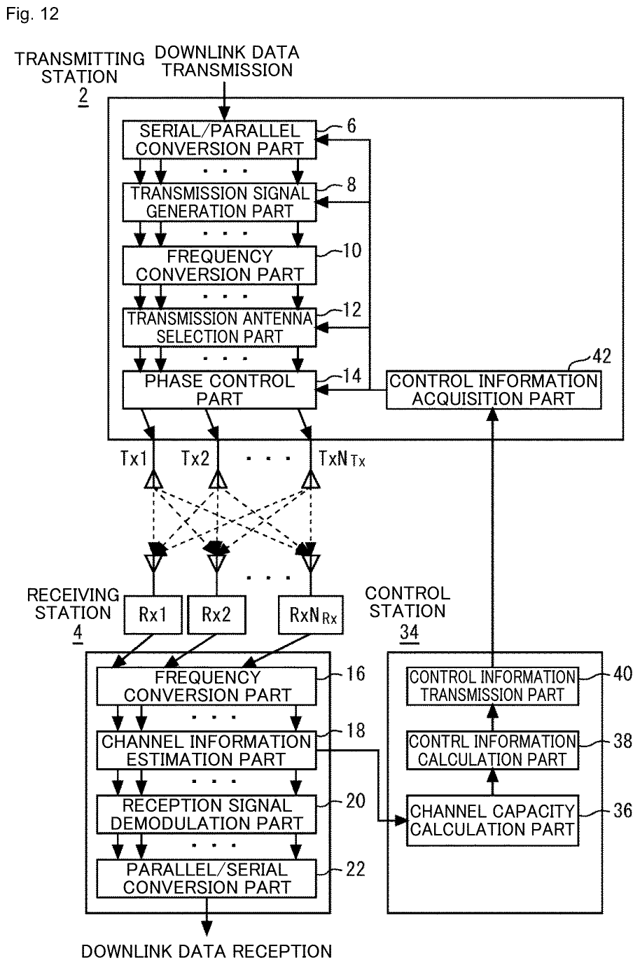

FIG. 12 is a functional block diagram of a wireless communication system according to the third embodiment of the present disclosure. Since the normal downlink data path is the same as that in the first embodiment, the path for processing known pilot signals will be described herein.

First, as in the first embodiment, a pilot signal is transmitted from the transmitting station 2 to the receiving station 4. The channel information estimation part 18 which has received the pilot signal estimates the channel information H before precoding and transmits the channel information H to the channel capacity calculation part 36 of the control station 34.

The channel capacity calculation part 36 estimates channel capacities for all conceivable combinations by performing the same processing as the channel capacity calculation part 28 described above and transmits the estimated channel capacities to the control information calculation part 38. The control information calculation part 38 determines information necessary for maximizing the channel capacity through the same processing as the control information calculation part 30 described above. Also, the information is transmitted to the control information transmission part 40. The information is transmitted using the control information transmission part 40 to the control information acquisition part 42 of the transmitting station 2 and transmitted using the control information acquisition part 42 to the serial/parallel conversion part 6, the transmission signal generation part 8, the transmission antenna selection part 12, and the phase control part 14. With this feedback, this embodiment realizes optimization of wireless communication.

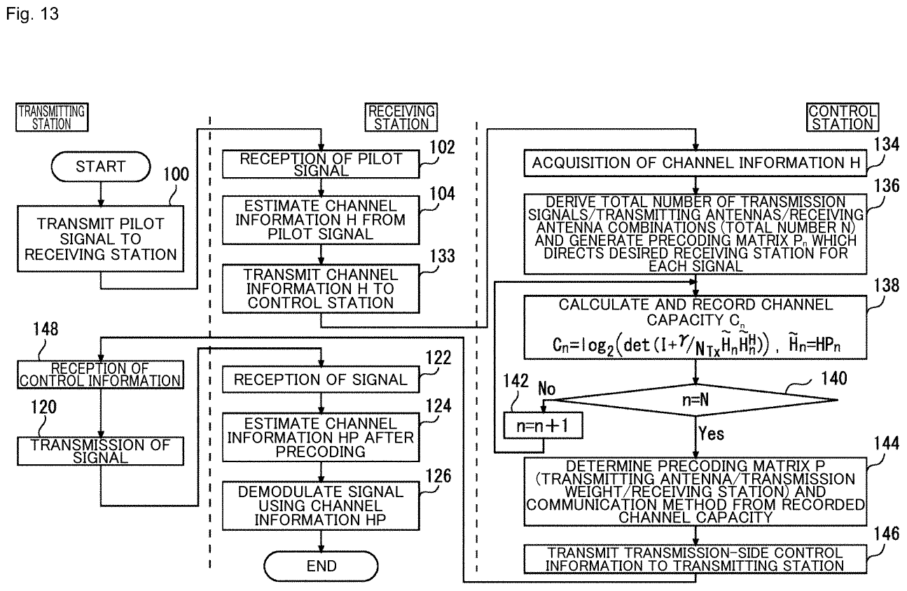

FIG. 13 is a flowchart for describing an operation example of a transmitting station, a receiving station, and a control station according to the third embodiment of the present disclosure. The process from the transmitting station 2 transmitting a known pilot signal to the receiving station 4 in Step 100 to the receiving station 4 estimating the estimated channel information H in Step 104 is the same as in the first embodiment. In subsequent Step 133, the receiving station 4 transmits the estimated channel information H to the control station 34.

In Step 134, the channel capacity calculation part 36 of the control station 34 obtains the channel information H transmitted from the receiving station 4. Subsequently, in Step 136, the channel capacity calculation part 36 derives all combinations of the number of transmission signals/transmitting antennas/receiving antennas and generates an optimal precoding matrix for all the combinations. Here, the precoding matrix is a matrix Pₙ (n=1, 2, . . . , N) including the information on the number of transmission signals/transmitting antennas/receiving antennas, where N is the total number of all combinations described above.

Subsequently, in Step 138, the channel capacity Cn of all combinations is derived by using the channel information H and the precoding matrix Pₙ and the recorded data is transmitted to the control information calculation part 38. The channel capacity Cn is derived using Expression 1.

Subsequently, in Step 140, it is confirmed whether n=N is satisfied. When n=N is not satisfied, the process proceeds to Step 142 and the process of Step 138 is repeatedly performed using n=n+1 as n. When n=N is satisfied, the process proceeds to Step 144.

In Step 144, the control information calculation part 38 selects the channel capacity C which has a maximum value from the input channel capacities. Furthermore, the precoding matrix P used for the derivation is obtained and information such as the number of transmission signals included in the precoding matrix P, the antennas that output each signal, and the phase coefficient of each antenna is stored. Furthermore, information such as the modulation multilevel number of the signal and the communication method such as the error correction coding rate is determined on the basis of the channel capacity C. These pieces of information are used as transmission-side control information.

In Step 146, the control information transmission part 40 transmits the transmission-side control information determined in Step 144 to the control information acquisition part 42. In Step 148, the control information acquisition part 42 of the transmitting station 2 first acquires the transmission-side control information. Also, the transmission-side control information is output to the serial/parallel conversion part 6, the transmission antenna selection part 12, and the phase control part 14 of the transmitting station, respectively.

In addition, in Step 120, the signals to be actually exchanged are transmitted from the transmitting station 2 to the receiving station 4. The processing from Step 120 to Step 126 is the same as in the first embodiment.

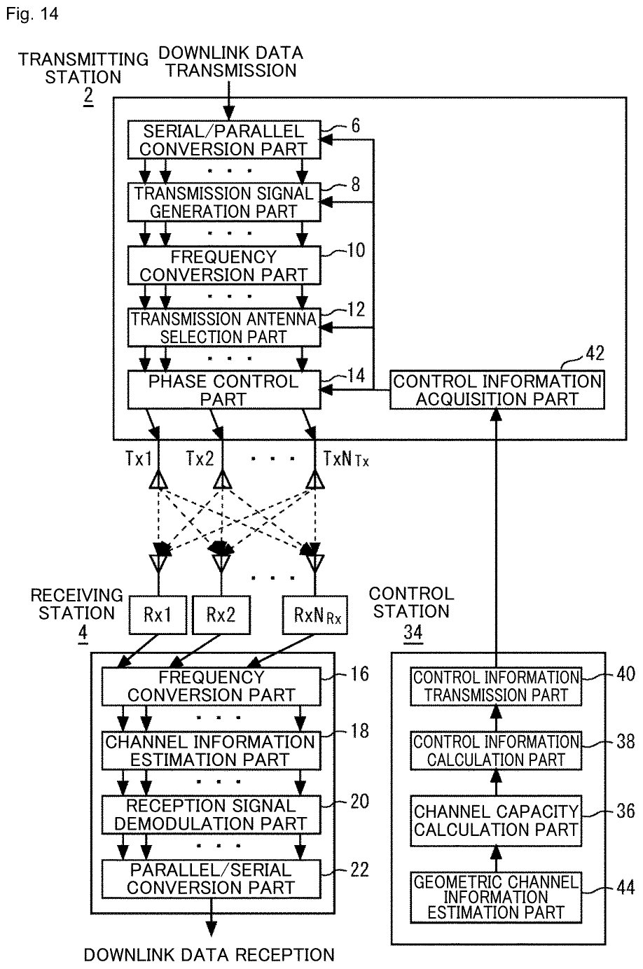

FIG. 14 is a diagram illustrating a configuration example of a wireless communication system according to a fourth embodiment of the present disclosure. Although this wireless communication system is similar to the third embodiment in that it includes a control station 34 in addition to the transmitting station 2 and the receiving station 4, the difference therebetween is that a geometric channel information estimation part 44 of the control station 34 is used for channel information estimation.

The geometric channel information estimation part 44 uses a wireless wave propagation model from the positional relationship between a transmitting antenna Tₓ and a receiving antenna Rₓ, and propagation space conditions such as weather and estimates channel information using a computer. Wireless wave propagation models which can be used include estimation expressions, ray tracing, and machine learning.

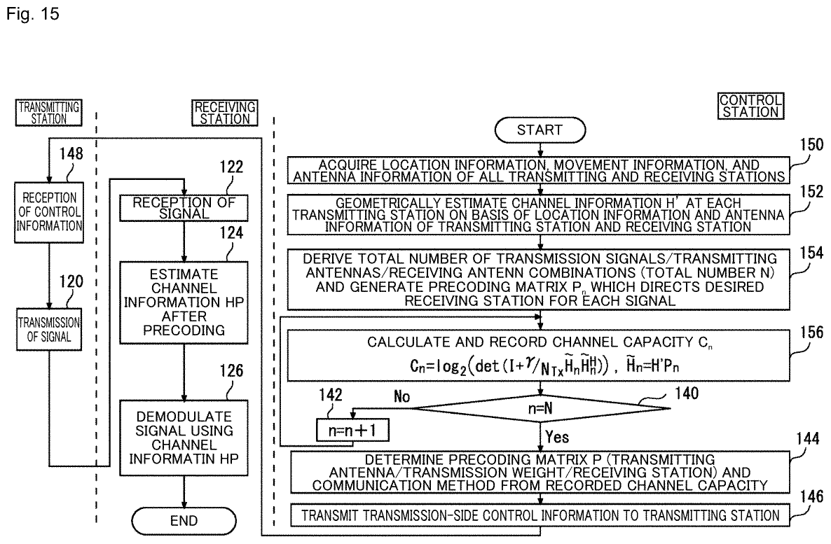

FIG. 15 is a flowchart for describing an example of an operation of the transmitting station, the receiving station, and the control station according to the fourth embodiment of the present disclosure. First, in Step 150, the geometric channel information estimation part 44 acquires the position information, the movement information, and the antenna information of all of the transmitting stations 2 and the receiving stations 4.

This information includes positional information of transmitting antennas and receiving antennas and propagation space conditions such as weather. For example, in the case of a satellite feed link MIMO in which the transmitting station is an LEO satellite and the receiving station is a ground station, it is possible to obtain orbit information, satellite antenna configuration information, and a positional relationship of the transmitting and receiving antennas from the ground station antenna arrangement. Furthermore, propagation space conditions such as the weather can be obtained from nowcast information published by the Japan Meteorological Agency.

Subsequently, in Step 152, channel information H′ at the location of each transmitting station is geometrically estimated on the basis of the above location information and antenna information. Subsequently, in Step 154, the channel capacity calculation part 36 derives all combinations of the number of transmission signals/transmitting antennas/receiving antennas and generates a precoding matrix Pₙ which is optimal for all the combinations.

Subsequently, in Step 156, the channel capacity Cₙ of all combinations is derived by using the channel information H′ and the precoding matrix Pₙ and the recorded data is transmitted to the control information calculation part 38. The channel capacity Cₙ can be derived using Expression 13.

$${C}_{n} = {log}_{2} ( det ( I + γ / {N}_{T x} , {\tilde{H}}_{n} {\tilde{H}}_{n}^{H} ) ) , {\tilde{H}}_{n} = {H}^{′} {P}_{n} \qquad [ Math . 13 ]$$

Subsequently, in Step 140, it is confirmed whether n=N is satisfied. When n=N is not satisfied, the process proceeds to Step 142 and the process of Step 156 is repeatedly performed using n=n+1 as n. When n=N is satisfied, the process proceeds to Step 144. Subsequent Steps 148 and 120 to 126 are the same as those described above.

### REFERENCE SIGNS LIST

1 Wireless communication system
2 Transmitting station
4 Receiving station
6 Parallel conversion part
8 Transmission signal generation part
12 Transmission antenna selection part
14 Phase control part
18 Channel information estimation part
20 Reception signal demodulation part
28 Channel capacity calculation part
30 Control information calculation part
32 Channel information estimation part
36 Channel capacity calculation part
38 Control information calculation part
Rₓ Receiving antenna
Tₓ Transmitting antenna

1. A wireless communication system using a transmitting station and a receiving station including a plurality of antennas, wherein
at least one of the transmitting station and the receiving station includes a processor,
the processor performs:
estimating channel information between the transmitting antenna and the receiving antenna;
deriving all combinations of sub-array configurations in accordance with the number of transmitting antennas, the number of receiving antennas and the number of transmission signals;
deriving a precoding matrix which allows in-phase combining for selected receiving antennas for all the combinations;
calculating channel capacity for all combinations from the channel information and the precoding matrix;
selecting an optimal precoding matrix which maximizes the channel capacity; and
determining transmission-side control information from the optimal precoding matrix,
the transmitting station performs:
switching an output destination of a single or a plurality of signals on the basis of the transmission-side control information and forming an arbitrary sub-array corresponding to each signal; and
performing in-phase combining using phase control on the desired receiving antenna using the sub-array, and
the receiving station performs combining, separating, and demodulating the signals transmitted from the transmitting station.

2. The wireless communication system according to claim 1, wherein a known pilot signal is used at the time of estimating the channel information.

3. The wireless communication system according to claim 1, wherein geometric estimation is used at the time of estimating the channel information.

4. A wireless communication method using a transmitting station and a receiving station including a plurality of antennas, comprising:
estimating channel information between a transmitting antenna and a receiving antenna;
deriving all combinations of sub-array configurations according to the number of transmitting antennas, the number of receiving antennas, and the number of transmission signals;
deriving a precoding matrix which allows in-phase combining for the selected receiving antennas for all the combinations;
calculating channel capacity for all combinations from the channel information and the precoding matrix;
selecting an optimal precoding matrix which maximizes the channel capacity;
determining transmission-side control information from the optimal precoding matrix;
switching an output destination of a single or a plurality of signals on the basis of the transmission-side control information and forming an arbitrary sub-array corresponding to each signal;
performing in-phase combining by performing phase control on the desired receiving antenna using the sub-array; and
combining, separating, and demodulating signals transmitted from the transmitting station.

5. A wireless communication device, comprising one or more circuitry,
the circuitry performs:
estimating channel
information between a transmitting antenna and a receiving antenna,
deriving all combinations of sub-array configurations according to the number of transmitting antennas, the number of receiving antennas, and the number of transmission signals,
deriving a precoding matrix which allows in-phase combining for the selected receiving antennas for all the combinations, and
calculating a channel capacity for all combinations from the channel information and the precoding matrix,
selecting an optimal precoding matrix which maximizes the channel capacity,
determining transmission-side control information from the optimal precoding matrix,
parallelizing bit information into the number of transmission signals on the basis of the transmission-side control information,
modulating a bit string on the basis of the transmission-side control information and converting it into an electrical signal,
selecting an antenna on the basis of the transmission-side control information to switch an output destination of a single or a plurality of signals and configure a sub-array of an arbitrary shape,
controlling a phase coefficient so that in-phase combining is performed on a desired receiving antenna on the basis of the transmission-side control information, and
increasing a received SNR by performing signal combining on the basis of the channel information, and
separating interfering signals.
